(19) United States
(12) Patent Application Publication
(10) Pub. No.: US 2013/0249761 A1
(43) Pub. Date: Sep. 26, 2013

(54) Smart Antenna for Wireless Communications

(71) Applicants: Tian Hong Loh, Teddington (GB); Haitao Liu, Beijing (CN); Steven Gao, Canterbury (GB)

(72) Inventors: Tian Hong Loh, Teddington (GB); Haitao Liu, Beijing (CN); Steven Gao, Canterbury (GB)

(21) Appl. No.: 13/876,140

(22) PCT Filed: Sep. 27, 2011
(86) PCT No.: PCT/GB2011/051826

§ 371 Date: May 31, 2013

(30) Foreign Application Priority Data
Sep. 27, 2010 (GB) 1016203.0

(51) Int. Cl. H01Q 15/00; H01Q 3/44

(52) U.S. Cl. CPC H01Q 15/0006; H01Q 3/44
USPC 343/833

(57) ABSTRACT

A smart antenna includes a plurality of parasitic antenna elements provided with varactors, a voltage supply arranged to be coupled to the varactors and operable to supply a DC voltage, and a control unit operable to tune DC voltages applied to the varactors, wherein each parasitic antenna element can be reconfigured either as a reflector or a director on the basis of the voltage applied thereto. The driven element is surrounded by first and second 10 annular arrays of parasitic elements at radii of substantially 25 and 50 mm respectively, each annular array including six antenna elements. The array is configurable for steering the beam. The arrangement is compact and efficient.

The present invention relates to an antenna and in the preferred embodiments to a compact low cost smart antenna for wireless communications use.

A smart antenna can steer its main beams towards desired users while forming nulls in the directions of interference signals. It is one of the key technologies for future generations of terrestrial wireless communications, satellite communications and radars. It can increase the capacity of wireless communication networks significantly by increasing the spectrum efficiency while at the same time reducing the transmitted power.

A smart antenna, with its increased gain, can reduce the Signal-to-Noise (SNR) over a digital link and hence reduce the bit error rate (BER) of the communications link. This allows modern receivers to operate at higher data rates.

A traditional smart antenna consists of an array of many antenna elements, with each element requiring its own receive and transmit RF front end including RF filters, low noise amplifiers, a mixer and RF power amplifiers. Each element also needs its own analogue-to-digital (A/D) and digital-to-analogue (D/A) converters. These make the smart antenna very expensive and bulky, which prevents it from being used in a wide variety of applications in commercial wireless communication networks.

An Electronically Steerable Parasitic Array Radiator (ESPAR) antenna is a promising structure for constructing a low cost smart antenna system, which employs a single RF front end. The phase shifting performance of an ESPAR antenna can be achieved by tuning the reactive load of each element by using low-cost varactors for instance. A typical ESPAR structure consists of one fixed driven element and several tunable parasitic elements surrounding the driven element. The most widely studied ESPAR antenna comprises seven ¼ wavelength monopoles mounted vertically and scanned in the horizontal plane. One ¼ wavelength monopole is placed in the centre of the array and the other six ¼ wavelength monopoles are placed around it, equally spaced on a ½ wavelength diameter circle. The reported ESPAR antennas have reported gains in the region of 2 to 4 dBi. These antenna gains are, however, small and often too small to work at the high data rates desired.

An electronic beam-scanning antenna with a high gain was presented in H. Scott and V. F. Fusco in “360° Electronically controlled beam scan array”, IEEE transactions on antennas and propagation, Vol. 52, No. 1, January 2004. This had a gain of 12 dBi over a full 360° azimuth scan range. It comprised a circular array of 25 wire elements arranged over a ground plane in two concentric rings. Each parasitic element was loaded with a two-state reactive element allowing them to be arranged as an array of reflectors.

The present invention seeks to provide an improved smart antenna and preferably an improved low cost smart antenna.

According to an aspect of the present invention, there is provided a smart antenna including a plurality of parasitic antenna elements provided with configuring devices, a voltage supply arranged to be coupled to the configuring devices and to supply a DC voltage, and a control unit operable to tune DC voltages applied to the configuring devices, wherein each parasitic antenna element can be reconfigured either as a reflector or a director on the basis of the voltage applied thereto.

The configuring devices could be any of a number of electronic components. In the preferred embodiment, each configuring device includes a varactor or a pin diode.

Advantageously, the smart antenna employs a reconfigurable directional antenna as the driven element. This produces a driven element whose beam can be steered, in the preferred embodiment, in the directions of 90° and 270°, 30° and 210°, and 150° and 330°.

The preferred embodiments provide an electronically beam-switching or beam-scanning smart antenna having small size and low cost, which is able to achieve a gain of over 10 dBi. There is described below the preferred structure for such a small smart antenna. It will be appreciated that the terms beam-switching and beam-scanning normally depict the same functionality and may thus be used interchangeably.

The preferred embodiment provides a compact low-cost electronically beam-switching or beam-scanning smart antenna that covers the frequency band from 2.45 GHz to 2.55 GHz. The driven element is a directional antenna which includes three Inverted F-type Antenna (IFA) elements. In addition to the driven element, there are in the preferred embodiment twelve IFA parasitic elements arranged around the driven element and loaded with configuring devices (typically varactors or pin diodes). By tuning the DC voltages applied to the configuring devices, each parasitic IFA antenna element can be reconfigured either as a reflector or a director. This provides the switching or scanning mechanism for the beam. The antenna preferably has a radius of 50 mm and a height of 40 mm Compared to other beam-switching smart antennas, this antenna is smaller in size and lower in cost and higher gain.

Advantageously, the driven element is surrounded by at least one annular array of parasitic elements. This increases the gain of the smart antenna thereby enabling a size reduction compared to prior art devices. In the preferred embodiment, the driven element is surrounded by at least first and second annular arrays of parasitic elements. In theory, there is no limitation to the number of annular arrays of parasitic elements, the greater the number of annular arrays in theory increasing antenna gain but contributing to greater cost and greater antenna volume. It has been found that two annular arrays of parasitic elements provides a good balance between performance, cost and size.

It is preferred that each annular array is circumferentially symmetric. There could be in each array six or twelve or other even multiple of three antenna elements.

Embodiments of the present invention are described below, by way of example only, with reference to the accompanying drawings, in which:

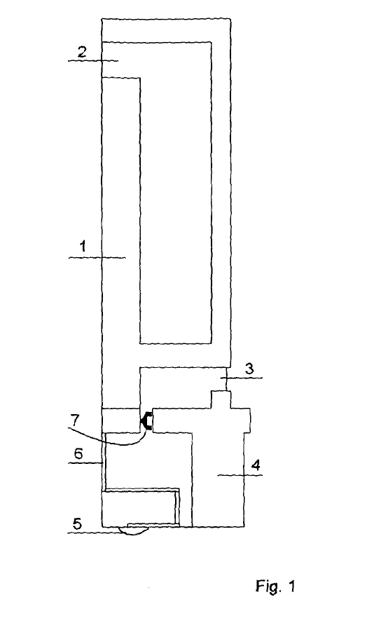

FIG. 1 shows in schematic form the IFA structure used to form a preferred embodiment of driven element;

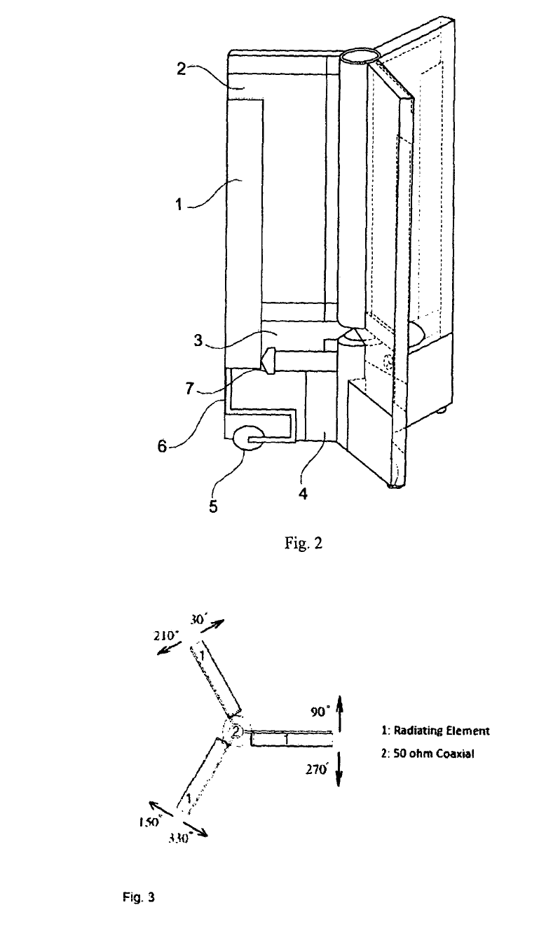

FIG. 2 shows an example of the reconfigurable driven element composed of three IFA radiating elements;

FIG. 3 shows a plan view of an example of ESPAR antenna composed of three IFA radiating elements;

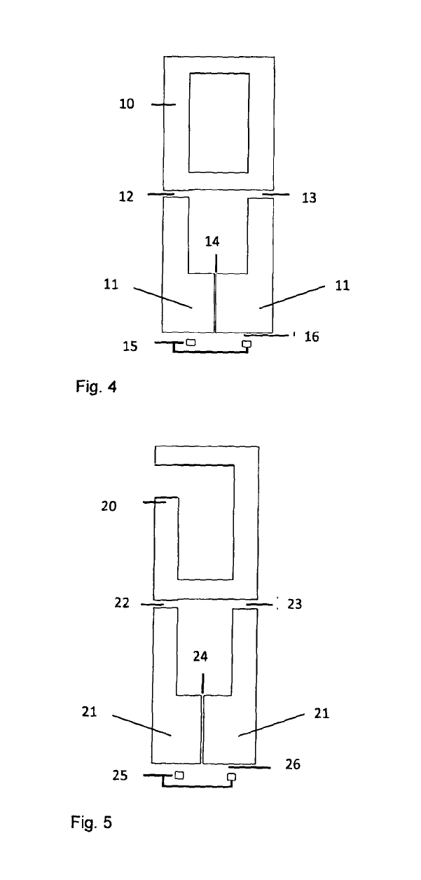

FIG. 4 shows the structure of the parasitic element at inner circle

FIG. 5 shows the structure of the parasitic element at outer circle

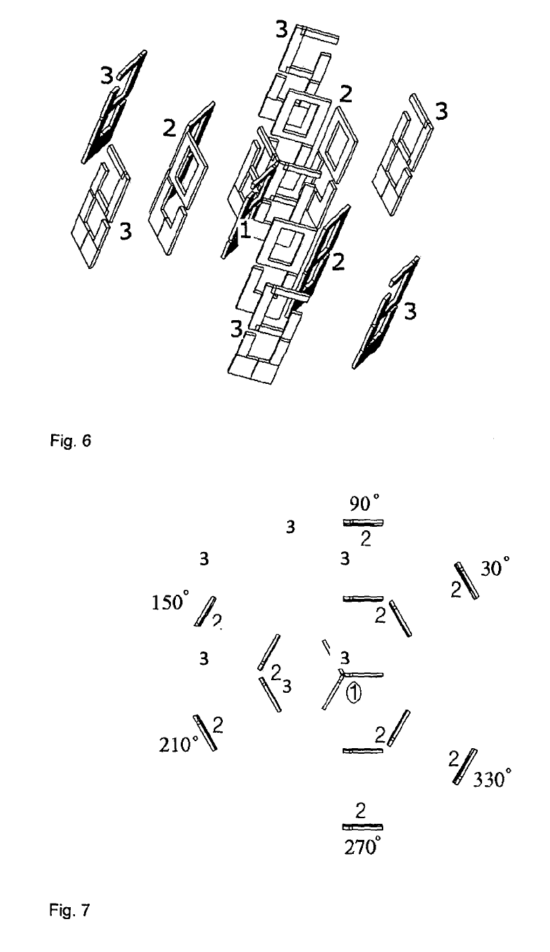

FIG. 6 is a 3D model of a preferred embodiment of high gain ESPAR antenna;

FIG. 7 is a plan view of the high gain ESPAR antenna of FIG. 6;

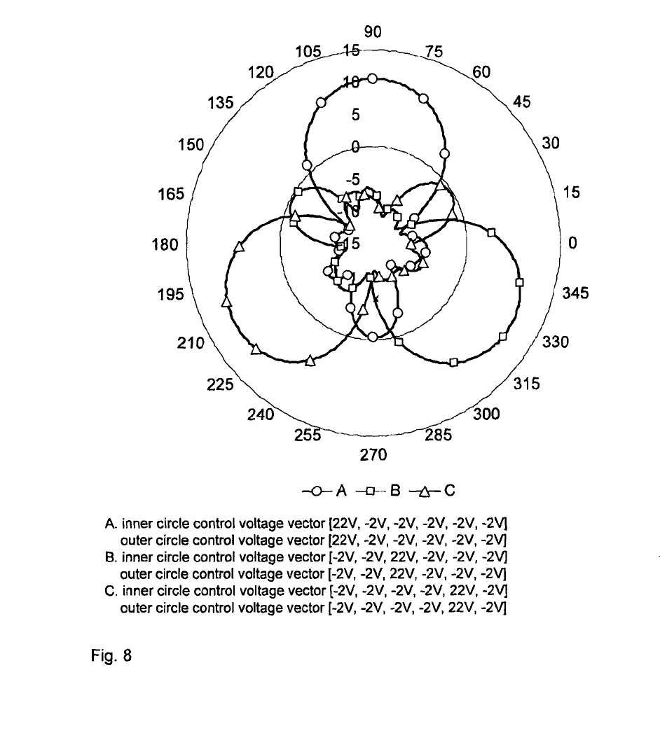

FIG. 8 shows the primary radiation pattern of the high gain ESPAR antenna of FIGS. 6 and 7; and

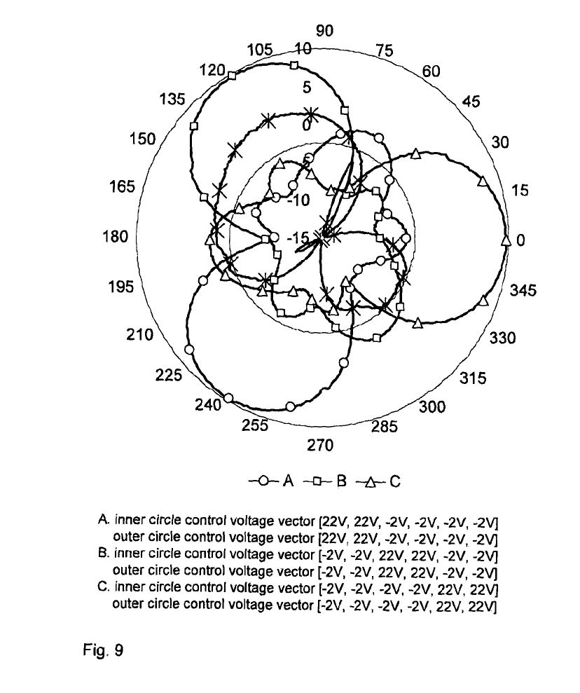

FIG. 9 shows the secondary radiation pattern of the high gain ESPAR antenna of FIGS. 6 and 7.

Generally, in a traditional ESPAR antenna, the centre driven element 1 is an omni-directional antenna, which excites all parasitic elements 2 and 3 uniformly. To increase the antenna gain, the smart antenna preferably employs a reconfigurable directional antenna as the driven element 1. This produces a driven element whose beam can be steered in the directions of, in this example, 90° & 270°, 30° & 210°, and 150° & 330°.

The preferred antenna employs two circles of parasitic elements 2 and 3 as shown particularly in the plan view of FIG. 7. The purpose of a double-circle structure is to further increase the antenna gain. Each parasitic element 2 and 3 can be reconfigured either as a reflector or a director as required.

### A. Radiating Elements

### 1) IFA Antenna Structure

The preferred embodiments of inverted F-type antenna (IFA) typically comprise three elements: a rectangular wire antenna located above a ground plane, a feeding mechanism and a shorting pin connected to ground. The IFA antenna is a good choice for an electrically small antenna as its input impedance can be easily matched by carefully tuning the shorting pin's position.

FIG. 1 shows the IFA structure preferably used for the driven element, which is both electrically small and reconfigurable. The antenna includes a substrate 2 upon which the elements of the antenna are supported. A copper radiating element 1 of the IFA is disposed on the substrate, as is a driven element 3. A 50 Ohm (typical) coaxial cable is in practice connected to the driven element 3. For a parasitic element, this it is where a varactor will be soldered.

The IFA ground plane 4 continues on the other side of the substrate, as shown in FIG. 2. A DC network 6 is applied between the ground plane 4 and a blocking capacitor 5.

The driven element is provided by a PIN diode 7. In such a configuration, the capacitor 5 is used for the parasitic element. The shorting pin in the IFA is connected to ground via the PIN diode 7.

### 2) Operation State Description

As the driven element, the radiating element of FIG. 1 can be reconfigured into two operating modes:—the active mode and the dummy mode. These are operated as follows:

| | | Control |
|---|---|---|
| Mode | Pin Switch | Voltage |
| Active Mode | “ON” | 2 V |
| Dummy Mode | “OFF” | 0 V |

As the parasitic element, the radiating element of FIG. 4 and FIG. 5 can be reconfigured into two operating modes: the reflector mode and the director mode. These are operated as follows:

| Mode | Varactor | Control Voltage |
|---|---|---|
| Reflector | Shorting | forward |
| Mode | | biased, −2 V |
| Director | Provide | reverse |
| Mode | Capacitance | biased, +22 V |

It will be appreciated that the above depicts just one embodiment in which the driven element is provided with a pin diode and the parasitic elements are provided with varactors, as the configuring devices. Other embodiments will use different configuring devices, be they pin diodes, varactors or other suitable devices.

### B. Driven Element

### 1) Driven Antenna Structure

By configuring three elements as shown in FIG. 1, a driven element can be built around one 50 Ohm RF port. FIGS. 2 and 3 show this structure. FIG. 3 is a view in plan and shows that the elements are preferably equally spaced by 120° in azimuth. The three elements are all soldered onto a centrally located coaxial cable. In this way, the three driven elements are excited by the same RF source.

By soldering the IFA radiating element onto a coaxial cable, these three IFA radiating elements merge with each other. All IFA radiating elements can be excited by the same RF source.

### 2) Driven Element Operation State

Each driven element is defined by its angular positions at 0°, 120° and 240°. The direction of the beams is as follows:

| Beam | Pin Switch | Pin Switch | Pin Switch |
|---|---|---|---|
| Direction | 0° Element | 120° Element | 240° Element |
| 90° & 270° | “ON” | “OFF” | “OFF” |
| 30° & 210° | “OFF” | “ON” | “OFF” |
| 150° & 330° | “OFF” | “OFF” | “ON” |
| 0° & 180° | “OFF” | “ON” | “ON” |
| 120° & 300° | “ON” | “OFF” | “ON” |
| 240° & 60° | “ON” | “ON” | “OFF” |

### C. Parasitic Element

The parasitic element can be reconfigured either as a director or as a reflector. By changing the capacitance provided by the varactor, the reflected phase of parasitic element can be tuned.

The structure of parasitic elements at inner circle is given in FIG. 4. A copper radiating element 10 of the IFA is disposed on the substrate. A 10 nH inductor is soldered at position 13 and a varactor is soldered at 12. The DC filtering capacitor of 10 g is soldered at 14 and 100 nH RF chocking inductor is soldered at 16 between the radiating element 11 and soldering pad 15. The structure of parasitic elements at outer circle is given in FIG. 5. A copper radiating element 20 of the IFA is disposed on the substrate. A 25 nH inductor is soldered at position 23 and a varactor is soldered at 22. The DC filtering capacitor of 10 g is soldered at 24 and 100 nH RF chocking inductor is soldered at 26 between the radiating element 21 and soldering pad 25.

### D. Overall Structure of Proposed ESPAR Antenna

FIG. 6 shows a 3D model of the preferred embodiment of high gain ESPAR antenna. The parasitic elements 2 and 3 surround the centrally located reconfigurable driven element 1, in two concentric circles. The inner circle has a diameter of substantially 50 mm and the outer circle has a diameter of substantially 100 mm (radii of 25 and 50 mm respectively). Each ring possesses six IFA antennas. FIG. 6 shows this layout in a bird's eye view.

FIG. 8 shows the primary radiation pattern of the high gain ESPAR antenna. The optional direction of primary pattern is 0° and 90°, 30° and 210° and 150° and 330°. For primary radiation patterns, one parasitic element is configured as the director at each circle. Note that the parasitic element with reverse biased control voltage is configured as the director. All other parasitic elements are configured as reflectors.

The secondary radiation pattern of the preferred embodiment of high gain ESPAR antenna is given in FIG. 9. The optional direction of primary pattern is 120° and 300°, 60° and 240° and 0° and 180°. For secondary radiation patterns, there are two parasitic elements configured as directors at each circle. All other parasitic elements are configured as reflectors.

The adaptive beam steering method enables the ESPAR antenna to estimate the direction of the desired signal and form the main lobe towards the desired signal. The adaptive algorithm employed in the preferred embodiment is an un-blinded algorithm and a reference signal is used to carry out the adaptive algorithm.

First, the algorithm searches the best cross correlation co-efficiency (CCC) value from those six main patterns and determines the starting point of the following iteration. After determining the starting point, the algorithm iterates following the steepest gradient of CCC. Beam forming is achieved by controlling the voltage applied across the varactors. By tuning the reactive loads of the varactors, the phase of the surface currents on the parasitic elements can be controlled.

A low-cost small smart antenna with high gain has been described above. By electronically switching the beams, the antenna can cover a full range of 360°. The simulation results show that the beam-switching smart antenna composed of reconfigurable IFA antenna elements can achieve a gain of between 8.5 to 10.5 dBi. It achieves a gain higher than that of most ESPAR antennas reported so far. The antenna has a radius of 0.4λ and a height of 0.3λ only. The antenna can thus have a compact size and be low cost and can thus be useful for applications such as wireless routers, mobile communications base stations, direction finding and so on.

It is to be understood that the described embodiments are preferred only and that these could be modified without loss of the desired functionality. For instance, the driven element does not have to be a directional antenna composed of three Inverted F-type Antenna (IFA) elements, a different number of IFA elements could be used. Similarly, instead of twelve IFA parasitic elements arranged around the driven element and loaded with varactors, the antenna can have a different number of IFA parasitic elements.

1. A smart antenna including a plurality of parasitic antenna elements provided with configuring devices, a voltage supply arranged to be coupled to the configuring devices and to supply a DC voltage, and a control unit operable to tune DC voltages applied to the configuring devices, wherein each parasitic antenna element can be reconfigured either as a reflector or a director on the basis of the voltage applied thereto, wherein the smart antenna includes a driven element which is a reconfigurable directional antenna including first, second and third inverted F-type antenna (IFA) elements angularly spaced from one another.

2. A smart antenna according to claim 1, wherein each configuring device includes a varactor or a pin diode.

3. A smart antenna according to claim 1, wherein the antenna elements are angularly spaced from one another by 120 degrees.

4. A smart antenna according to claim 1, wherein the antenna elements are coupled to a common centrally located coaxial cable.

5. A smart antenna according to claim 1, including twelve IFA parasitic elements arranged around the driven element and loaded with varactors.

6. A smart antenna according to claim 1, wherein the centrally located coaxial DC voltages applied to the varactors are tunable so as to reconfigure each parasitic IFA antenna element either as a reflector or a director.

7. A smart antenna according to 6, wherein said tunability provides a switching or scanning mechanism for the antenna beam.

8. A smart antenna according to claim 1, wherein the driven element is surrounded by at least one annular array of parasitic elements.

9. A smart antenna according to claim 8, wherein the driven element is surrounded by at least first and second annular arrays of parasitic elements.

10. A smart antenna according to claim 9, wherein the first and second parasitic elements are at radii of substantially 25 mm and 50 mm, respectively.

11. A smart antenna according to claim 9, wherein each annular array is circumferentially symmetric.

12. A smart antenna according to claim 11, wherein each annular array includes six or twelve or other even multiple of three antenna elements.

13. A smart antenna according to claim 8, wherein for the generation of a primary radiation pattern, one parasitic element is configured as a director in each annular array.

14. A smart antenna according to claim 13, wherein the director is said one parasitic element driven by a reverse biased control voltage.

15. A smart antenna according to claim 13, wherein all other parasitic elements are configured as reflectors.

16. A smart antenna according to claim 8, wherein for secondary radiation patterns two parasitic elements are configured as directors in each annular array with all other parasitic elements configured as reflectors.

17. A smart antenna according to claim 1, wherein the antenna has a radius of substantially 50 mm and a height of substantially 40 mm.

18. A smart antenna according to claim 1, wherein the driven element is a reconfigurable antenna operable to generate a beam steerable in the directions of 90° and 270°, 30° and 210°, and 150° and 330°.

19. A smart antenna according to claim 1, wherein the antenna is operable in a frequency band from substantially 2.45 GHz to substantially 2.55 GHz.

20.-22. (canceled)
